(19) United States
(12) Patent Application Publication
(10) Pub. No.: US 2009/0057528 A1
(43) Pub. Date: Mar. 5, 2009

(54) Stabilizer Link Spring Block Bracket and Method

(76) Inventors: Lars David Moravy, Powell, OH (US); Jason Lee Fink, Marysville, OH (US); Christopher Eugene Dendis, Plain City, OH (US); Christopher Brian Dundon, Pataskala, OH (US)

Correspondence Address: CERMAK KENEALY & VAIDYA, LLP, 515 EAST BRADDOCK RD SUITE B, Alexandria, VA, 22314, US

(21) Appl. No.: 11/847,699

(22) Filed: Aug. 30, 2007

(51) Int. Cl. F16M 7/00; B23P 19/04; F16F 9/34

(52) U.S. Cl. 248/674; 188/266.5; 29/700

(57) ABSTRACT

A structural member and method are provided for attaching a vehicle motion damping mechanism to a chassis/suspension component of a vehicle. The vehicle motion damping mechanism can include a piston operatively mounted within a cylinder, and a coil spring disposed around at least a portion adjacent the cylinder. The structural member can include a bracket member that, if desired, can be manufactured as a single unit (or a multi-part unit), and can be configured to interconnect the chassis/suspension component of the vehicle and the vehicle motion damping mechanism. The bracket can include a first portion adapted to be connected to the chassis component of the vehicle, a second portion adapted to be connected to the cylinder of the vehicle motion damping mechanism, and a third portion protruding radially outward from the cylinder of the vehicle motion damping mechanism. The third portion of the unitary bracket can be configured to prevent damage to the vehicle caused by a broken or disconnected coil spring by being positioned in the path that the coil spring would follow in the event of a failure of the coil spring.

### BACKGROUND

A vehicle suspension system typically includes some sort of damping system to provide a smooth ride for a vehicle operator and to ensure stable steering qualities. The damping system can include a shock absorbing piston and cylinder arrangement and a coil spring, for example. A guard structure is sometimes provided to prevent damage that may result if the coil spring used in such a damping system becomes broken (e.g., breaks into separate pieces or becomes dislodged from its seat).

Damping devices have become standard components of passenger vehicle suspensions. Damping devices are particularly common on front wheel drive passenger vehicles, since damping device configurations are the most common form of suspensions for those vehicle drives. In vehicle suspension systems, damping devices typically are located at the front drive axle and serve as the vertical axis for the vehicle wheel assembly. Each damping device normally includes a shock absorbing mechanism comprising a piston slidably mounted within a cylinder, with the cylinder being at least partially surrounded by a coil spring. The shock absorber is the suspension's damping element for reducing the oscillatory movement of the wheel. The coil spring can be supported on the cylinder, and acts to cushion the vehicle body from shocks encountered by the wheel. Together, each shock absorbing mechanism and coil spring supports a significant portion of the total vehicle body weight and can be two of the principle support components for the vehicle body.

The architectural arrangement/configuration of the damping device or other damping mechanism can place a shock absorber and its associated coil spring assembly in close proximity to various structures within a vehicle's wheel well. If, for example, a worn, defective, or overstressed coil spring fractures or disconnects while the vehicle is operating, the spring in conventional damping device configurations can contact the various components within a vehicle wheel well, possibly resulting in physical damage to the various components and requiring expensive repair. Of course, the broken spring could also result in loss of suspension support resulting in poor riding characteristics for the vehicle.

The spring fracture and disconnection problems in conventional strut type vehicle suspensions are compounded by the frequent use of coil springs that have multiple diameters. Damping device coil springs can include both a lesser diameter portion and a greater diameter portion, with a continuous change between the diameters. The different diameters produce variable spring constants, and consequently cause the suspension to provide different amounts of support at differing strut loads. Conventionally, the smaller diameter portion of the spring is located at the spring's bottom. It is usually attached to the strut or shock absorber cylinder by resting on a relatively small diameter spring seat that is constructed of a disk mounted around the strut's cylinder. When spring fracture occurs, the larger diameter portion of the spring is often of a diameter larger than the spring seat, so that the larger diameter coils of the spring can fall beneath the spring seat to a position around the lower portion of the strut. Since vehicle brakelines are conventionally mounted on the strut near the strut's bottom, the probability of brakeline damage upon spring failure is greater when such variable diameter springs are used.

Regardless of the diameter of the spring, and regardless of the size of the spring seat, a fractured or disconnected spring can move to the lower portion of the damping device by “corkscrewing” around the strut (or shock absorber, etc.) and winding downward to beneath the spring seat. Again, the broken spring can then damage various components within the wheel well.

### SUMMARY

According to an aspect of the disclosed subject matter, a structural member can include a bracket configured to be interconnected between the suspension component of the vehicle and the vehicle motion damping mechanism. The bracket can include a first portion configured to be connected to the suspension component of the vehicle, a second portion configured to be connected to the cylinder of the vehicle motion damping mechanism, and a third portion configured to protrude radially outward from the cylinder of the vehicle motion damping mechanism. The third portion of the bracket can be configured to prevent damage to the vehicle caused by a failed coil spring by being positioned in a path that an end of the coil spring would follow in the event of a failure of the coil spring.

According to another aspect of the disclosed subject matter, a damping mechanism for a vehicle can include a cylinder extending between the wheel mount structure and the vehicle frame, a spring member located adjacent the cylinder, a bracket located adjacent the cylinder. The bracket can include a first portion having a connection portion configured to connect the vehicle suspension component to the damping mechanism, a second portion connected to the cylinder of the damping mechanism, and a third portion protruding radially outward from the cylinder of the vehicle motion damping mechanism and positioned in the path that an end of the coil spring would follow in the event of a failure of the coil spring such that the bracket is configured to prevent damage to the vehicle caused by a failed coil spring.

According to still another aspect of the disclosed subject matter, the connection structure of the first portion of the bracket can include a stabilizing link that is connected to a stabilizing bar which is connected to a second bracket and a second cylinder associated with a second wheel mount structure of the vehicle.

According to still another aspect of the disclosed subject matter, a method for attaching a vehicle motion damping mechanism to a vehicle suspension component can include providing the vehicle motion damping mechanism with a cylinder and a coil spring disposed adjacent the cylinder, and providing a bracket member including a first portion that is configured for connection to the vehicle suspension component, a second portion configured for connection to the cylinder of the vehicle motion damping mechanism, and a third portion that extends from the second portion of the bracket member. The method can include connecting the first portion of the bracket member to the vehicle suspension component via a stabilizing linkage, connecting the second portion of the bracket member to the cylinder of the vehicle motion damping mechanism, and positioning the third portion of the bracket member such that the third portion extends radially outward from the cylinder and in a path that an end of the coil spring would follow when a failure of the coil spring occurs, thereby preventing possible damage to the vehicle caused by a failure of the coil spring.

According to yet another aspect of the disclosed subject matter, a structural member can be provided for attaching a vehicle motion damping mechanism to a chassis or suspension component of the vehicle, the vehicle motion damping mechanism comprising a piston operatively mounted within a cylinder, and a coil spring disposed around at least a portion of the cylinder. The structural member can include a unitary bracket adapted to be manufactured as a single unit, and adapted to be interconnected between the chassis or suspension component of the vehicle and the vehicle motion damping mechanism. The unitary bracket can include a first portion adapted to be connected to the chassis or suspension component of the vehicle, a second portion adapted to be connected to the cylinder of the vehicle motion damping mechanism, and a third portion protruding radially outward from the cylinder of the vehicle motion damping mechanism.

The third portion of the unitary bracket can be configured and positioned to prevent damage to the vehicle caused by a broken coil spring by being positioned in the path a broken end of the coil spring would follow in the event of a failure of the coil spring.

The first portion of the unitary bracket can be adapted to be bolted or otherwise connected to the chassis or suspension component of the vehicle. Alternatively, the first portion of the unitary bracket can be adapted to be welded or otherwise fixed to the chassis component of the vehicle.

The chassis or suspension component of the vehicle can comprise one or more of various components including, but not limited to, a stabilizing linkage component, an axle assembly, a suspension component, etc.

The second portion of the unitary bracket can be adapted to be permanently joined to the cylinder of the vehicle motion damping mechanism, using joining methods that can include, but are not limited to, welding, brazing, soldering, etc. Alternatively, the second portion of the unitary bracket can be adapted to be joined to the cylinder of the vehicle motion damping mechanism using a fastening device such as a bolt, clamping mechanism, etc.

Still other features will become apparent to those skilled in the art from a reading of the following detailed description of embodiments constructed in accordance therewith, and taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1 is an illustration of a vehicle motion damping mechanism with a conventional bracket for attaching the vehicle motion damping mechanism to a vehicle suspension component, such as a stabilizer linkage component;

FIG. 2 is a perspective view of an embodiment of a vehicle motion damping mechanism with a bracket, made in accordance with principles of the invention; and

FIG. 3. is a perspective view of another embodiment of a vehicle motion damping mechanism with a bracket attached to a wheel mount structure and suspension system of a vehicle, and made in accordance with principles of the invention.

### DETAILED DESCRIPTION OF EXEMPLARY EMBODIMENTS

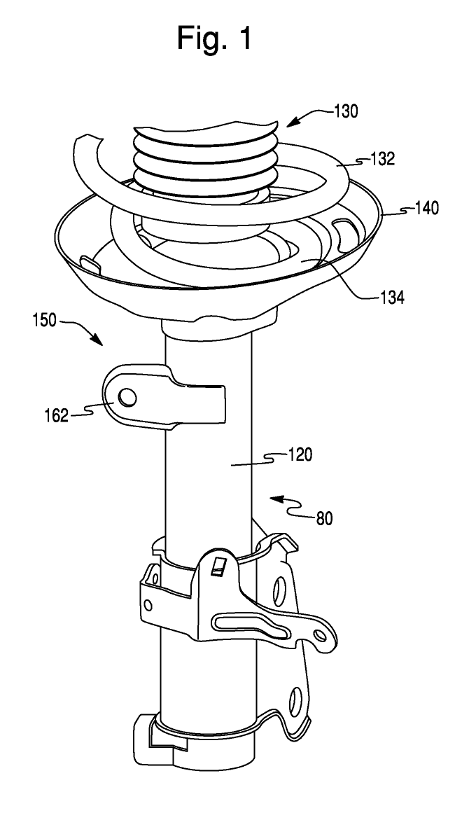

Referring initially to FIG. 1, a vehicle motion damping mechanism 150 is shown. The vehicle motion damping mechanism can include a shock absorber 80, comprising a piston (not shown) operatively mounted inside of a cylinder 120, and a coil spring 130 disposed around at least a portion of the cylinder 120. The coil spring 130 can include a larger diameter portion 132, and a smaller diameter portion 134, with the spring supported on a spring seat 140. A bracket 162 can be provided to attach the vehicle motion damping mechanism 150, or more precisely, the cylinder 120 of the vehicle motion damping mechanism 150 to a stabilizer linkage (not shown). The stabilizer linkage interconnects the cylinder 120 to a portion of the vehicle (such as the steering components, suspension components, or portions of the vehicle frame) via a stabilizer bar as is conventionally provided.

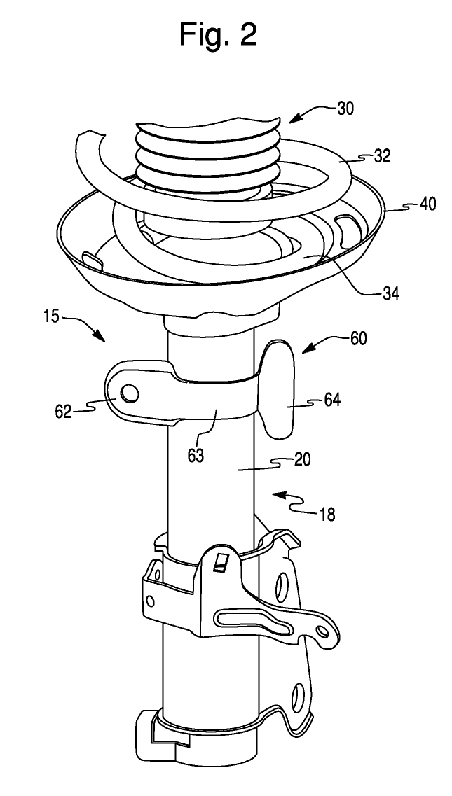

As shown in FIG. 2, a vehicle motion damping mechanism 15 according to an embodiment of the disclosed subject matter can include a shock absorber 18 that has a piston (not shown) operatively arranged within a cylinder 20. A coil spring 30 can be disposed around or adjacent to at least an upper portion of the cylinder 20. A dust guard can be provided within the spring 30 to protect the piston/cylinder of the shock absorber from being contaminated by dust, water or other debris. The coil spring 30 can include a larger diameter portion 32 and a smaller diameter portion 34, and can be supported by a spring seat 40 arranged around the cylinder 20.

As a result of the larger diameter portion of the coil spring 30 possibly being larger than the outer diameter of the annularly arranged spring seat 40, a failure of the coil spring 30 somewhere along the larger diameter portion 32 could result in a broken end of the coil spring 30 passing down over the spring seat 40 and causing damage to portions of the vehicle in the vicinity. Of course, the coil spring 30 can also be a uniform sized spring that, when broken or disconnected, can pass through, around or under the spring seat to corkscrew down the shock absorber 18.

The various components of a vehicle suspension system are described in U.S. Pat. No. 5,797,618, which is incorporated herein in its entirety by reference. One possible vehicle motion damping mechanism can comprise a McPherson strut-type damping mechanism. An independent front wheel suspension can include suspension components that are essentially formed on each side of the vehicle, and can include two vehicle motion damping mechanisms such as the mechanism 15 shown in FIG. 2. A stabilizer bar 90 can be provided to extend between the two independent vehicle motion damping mechanisms, with the stabilizer bar 90 being mounted by conventional means to chassis components of the vehicle.

The stabilizer bar 90 can be provided with two outer crank-like portions having ends which are adapted to follow the movements of the independent vehicle motion damping mechanisms, and thus those of the corresponding wheel, and which serve as a torsion spring in order to impede the swaying movements of the vehicle body when rounding a curve. The vehicle motion damping mechanism 15 can be disposed at an upper part of the stabilizer bar 90 in the vehicle body, and at the lower part thereof disposed in relation to the outer end part of a vehicle suspension arm 51 in order to allow the turning of the vehicle motion damping mechanism about its longitudinal axis and allow pivotal movements of the suspension arm 51. The suspension arm 51 can be pivotably arranged in the vehicle body as is well known to allow for pivoting of the suspension arm about a horizontal axis.

The vehicle motion damping mechanism 15 can include a tube or cylinder 20 having a built-in piston. The piston portion of the vehicle motion damping mechanism 15 can be linearly movable with a dampened movement along the longitudinal axis of the damping mechanism 15. The damping mechanism 15 can also support the coil spring 30, which is of a compression spring type, and can be configured to rest on a spring seat 40 attached to the cylinder 20. The vehicle motion damping mechanism 15 can be pivotably arranged in the vehicle body, normally in the wheel housing.

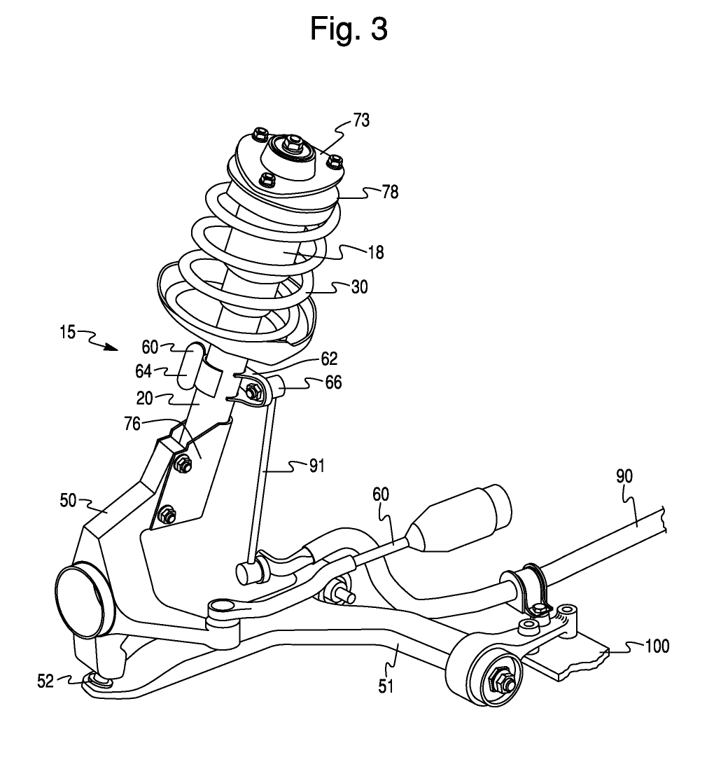

A stabilizer linkage 91 (shown in FIG. 3) can be pivotably connected between an end of the stabilizer bar 90 and each of the vehicle motion damping mechanisms mounted on each side of the vehicle. The cylinder 20 of each of the vehicle motion damping mechanisms 15 can be provided with a bracket 60 for attaching the vehicle motion damping mechanism to the stabilizer linkage 91.

As shown in FIG. 2, the bracket 60 can be formed as a unitary piece that includes a first portion 62, which can be joined to the stabilizer bar 90, a second portion 63, which can be joined to the cylinder 20 of the vehicle motion damping mechanism 15, and a third portion 64, which protrudes radially outward from and axially along a portion of the cylinder 20. The third portion can be configured and positioned to fall within the path that a broken or disconnected end of coil spring 30 would travel if it were to pass over, around or through the spring seat 40. The first portion 62 can include a connection structure 66, such as a nut and bolt or weld, which connects the bracket 60 to a suspension component (e.g., stabilizer bar 90, stabilizer linkage 91, etc.) of the vehicle.

The third portion 64 of the bracket 60 is configured and positioned relative to the vehicle motion damping mechanism 15 such that it can prevent possible damage to surrounding components of the vehicle, which may be caused by a broken or disconnected end of coil spring 30 in the case of a failure or disconnection of coil spring 30. As described above, failure or disconnection of the coil spring often results in the end of the spring passing the spring seat 40 and spiraling down around the cylinder 20 of vehicle motion damping mechanism 15. Manufacturability, improved reliability, ease of assembly, reduction of total number of parts, reduction of weight, reduction of space, and many other characteristics and benefits can be achieved as a result of including a mechanism for stopping the end of a coil spring, and forming the mechanism as an integral part of the bracket for attaching the vehicle motion damping mechanism to a vehicle suspension component, such as the stabilizer linkage 91.

FIG. 3 shows yet another embodiment of a bracket 60 and vehicle damping mechanism 15 connected to a vehicle suspension system. The vehicle suspension system can include a knuckle/wheel mount 50 that is connected to a vehicle frame via a lower control arm 51 and an upper link assembly, such as a damping mechanism that, in this embodiment, is formed as a strut. (If a four bar linkage is preferred, the strut can be replaced with an upper control arm and separate shock absorber).

The vehicle damping mechanism 15 can include a compression/dampening member such as shock absorber 18 and spring 30 that permit vertical movement of the knuckle/wheel mount 50 relative to the vehicle frame. A frame attachment plate 73 can be provided on an upper portion of the vehicle damping mechanism 15 for attachment to a different portion of the vehicle frame. A bracket 76 can be provided at an opposite lower end of the vehicle damping mechanism 15 for attachment to an upper portion of the knuckle/wheel mount 50. The vehicle damping mechanism 15 can include cylinder 20 that is connected to an upper portion of the knuckle/wheel mount 50 by the bracket 76 such that the knuckle/wheel mount 50 can rotate and turn with respect to the vehicle damping mechanism 15 and with respect to the vehicle frame. A bearing or rotary link member 78 can be located directly underneath the frame attachment plate 73 to provide relative movement between the vehicle damping mechanism 15 and the frame of the vehicle.

The knuckle/wheel mount 50 can be attached to the lower control arm 51 at joint 52. The joint 52 can be configured to permit the knuckle/wheel mount 50 to move in a substantially vertical motion with respect to the vehicle frame while also permitting the knuckle/wheel mount 50 to turn with respect to the lower control arm 51 and vehicle frame.

Stabilizer bar 90 can be connected to the vehicle frame 100 via a suspension bracket system, and connected to the vehicle damping mechanism 15 via stabilizer linkage 91 and bracket 60. The stabilizer linkage 91 can be configured so that movement of the cylinder 20 can be translated via the stabilizer bar 91 to the opposite wheel mount structure (specifically, to the opposite side upper rotary link member), to provide more stability to the vehicle suspension during cornering and other manoeuvres of the vehicle.

Bracket 60 can include a third portion 64 that extends perpendicularly away from the cylinder 20 and sized and shaped such that, if the coil spring 30 were to disengage or break, the third portion 64 would prevent the coil spring 30 from corkscrewing down the cylinder 20 and possibly damaging components of the vehicle. In this embodiment, the bracket 60 can be welded to the cylinder 20 of the vehicle damping mechanism 15.

While certain embodiments are described above, it should be understood that the invention can be embodied and configured in many different ways without departing from the spirit and scope of the invention. For example, the second portion 63 of the bracket 60 can be welded to the cylinder 20, spring seat 40, or other portion of the damping mechanism 15. In addition, the first portion 62 of the bracket 60 can be secured to the cylinder 20 via a nut and bolt mechanism that passes through mating openings in the bracket, or it could be riveted or otherwise clamped over the cylinder 20. The bracket 60 can also be attached to the damping mechanism 15 at locations other than the locations shown in the drawings. For example, it may be possible to locate the bracket above the spring seat 40. The shape of the third portion 64 can vary for different applications of the device, and in particular, will depend on the size and shape of the coil spring 30 and the configuration of the seat 40, among other factors. The bracket 60 can be a single unitary and integral member or can be composed of several parts that are interconnected or otherwise associated with each other.

While the subject matter has been described in detail with reference to exemplary embodiments thereof, it will be apparent to one skilled in the art that various changes can be made, and equivalents employed, without departing from the scope of the invention.

What is claimed is:

1. A structural member for attaching a vehicle motion damping mechanism to a suspension component of a vehicle, the vehicle motion damping mechanism including a cylinder and a coil spring, the structural member comprising:
a bracket configured to be interconnected between the suspension component of the vehicle and the vehicle motion damping mechanism, the bracket including,
a first portion configured to be connected to the suspension component of the vehicle,
a second portion configured to be connected to the cylinder of the vehicle motion damping mechanism, and
a third portion configured to protrude radially outward from the cylinder of the vehicle motion damping mechanism, the third portion of the bracket configured to prevent damage to the vehicle caused by a failed coil spring by being positioned in a path that an end of the coil spring would follow in the event of a failure of the coil spring.

2. The structural member of claim 1, wherein the first portion of the bracket includes a nut and bolt for connection to the suspension component of the vehicle.

3. The structural member of claim 1, wherein the first portion of the bracket includes a weld for connection to the suspension component of the vehicle.

4. The structural member of claim 1, wherein the suspension component of the vehicle includes one of a stabilizing linkage and an axle assembly.

5. The structural member of claim 1, wherein the bracket is a one piece integral unitary member.

6. The structural member of claim 1, wherein the second portion of the bracket is configured to be permanently joined to the cylinder of the vehicle motion damping mechanism.

7. The structural member of claim 1, wherein the second portion of the unitary bracket includes an attachment structure configured to be joined to the cylinder of the vehicle motion damping mechanism.

8. A damping mechanism for a vehicle, the vehicle including a wheel mount structure, a vehicle suspension component, and a vehicle frame, and the damping mechanism comprising:
a cylinder extending between the wheel mount structure and the vehicle frame;
a spring member located adjacent the cylinder;
a bracket located adjacent the cylinder and including,
a first portion including a connection portion configured to connect the vehicle suspension component to the damping mechanism, a second portion connected to the cylinder of the damping mechanism, and a third portion protruding radially outward from the cylinder of the vehicle motion damping mechanism and positioned in the path that an end of the coil spring would follow in the event of a failure of the coil spring such that the bracket is configured to prevent damage to the vehicle caused by a failed coil spring.

9. The damping mechanism of claim 8, wherein the connection structure of the first portion of the bracket includes a nut and bolt inserted through a hole in the bracket.

10. The damping mechanism of claim 8, wherein the connection structure of the first portion of the bracket includes a stabilizing link that is connected to a stabilizing bar which is connected to a second bracket and a second cylinder associated with a second wheel mount structure of the vehicle.

11. The damping mechanism of claim 8, wherein the second portion of the bracket includes means for permanently joining the bracket to the cylinder of the damping mechanism.

12. The damping mechanism of claim 8, further comprising:
a stabilizer bar connected to the connection portion of the first portion of the bracket.

13. The damping mechanism of claim 8, wherein the third portion includes a surface that extends substantially perpendicularly away from the cylinder and along a predetermined distance parallel to a longitudinal axis of the cylinder such that it is configured to prevent corkscrew type travel of the spring member down the cylinder.

14. The damping mechanism of claim 8, further comprising:
a spring seat located between the bracket and the spring member.

15. A method for attaching a vehicle motion damping mechanism to a vehicle suspension component, comprising:
providing the vehicle motion damping mechanism with a cylinder and a coil spring disposed adjacent the cylinder;
providing a bracket member including a first portion that is configured for connection to the vehicle suspension component, a second portion configured for connection to the cylinder of the vehicle motion damping mechanism, and a third portion that extends from the second portion of the bracket member;
connecting the first portion of the bracket member to the vehicle suspension component via a stabilizing linkage;
connecting the second portion of the bracket member to the cylinder of the vehicle motion damping mechanism;
positioning the third portion of the bracket member such that the third portion extends radially outward from the cylinder and in a path that an end of the coil spring would follow when a failure of the coil spring occurs, thereby preventing possible damage to the vehicle caused by a failure of the coil spring.

16. The method of claim 15, further comprising:
bolting the first portion of the bracket member to the stabilizing linkage of the vehicle.

17. The method of claim 15, further comprising:
welding the first portion of the bracket member to the stabilizing linkage of the vehicle.

18. The method of claim 15, further comprising:
permanently joining the bracket member to the cylinder of the vehicle motion damping mechanism.

19. The method of claim 15, further comprising:
removably connecting the bracket member to the cylinder of the vehicle motion damping mechanism.

20. The method of claim 15, wherein positioning the third portion of the bracket member includes preventing the coil spring, when failed, from spiraling down the cylinder of the shock absorbing device.
